(19) United States
(12) Patent Application Publication
(10) Pub. No.: US 2020/0123951 A1
(43) Pub. Date: Apr. 23, 2020

(54) METHOD AND SYSTEM FOR CONTROLLING INJECTION OF A REDUCING AGENT INTO AN EXHAUST GAS STREAM

(71) Applicant: GM Global Technology Operations LLC, Detroit, MI (US)

(72) Inventors: Claudio Ciaravino, Torino (IT); Fabrizio Ramolivo, Canale (IT); Michael A. Smith, Clarkston, MI (US); Bryan D. Axe, Farmington Hills, MI (US); Federico Luigi Guglielmone, Rivoli (IT)

(21) Appl. No.: 16/168,047

(22) Filed: Oct. 23, 2018

(51) Int. Cl. F01N 3/20; F01N 9/00; F01N 3/035; B01D 53/94

(52) U.S. Cl. CPC F01N 3/208; F01N 9/002; F01N 3/035; B01D 53/9418; B01D 53/9495; F01N 2900/1402; F01N 2900/1606; F01N 2900/0416; F01N 2610/146; F01N 2900/1818; F01N 2900/1811; F01N 2900/1404; F01N 2900/1411; F01N 2610/02

(57) ABSTRACT

An aftertreatment (AT) system for an exhaust gas stream of an internal combustion engine may comprise a selective catalytic reduction (SCR) device, a particulate filter (PF) device, a reducing agent injection system configured to inject a reducing agent into the exhaust gas stream at a location upstream of the SCR device. A reducing agent injection rate control system may be embedded in an engine control module and may be configured to calculate and output a reducing agent injection rate signal and to apply the injection rate signal to the injection system to control the amount of reducing agent injected into the exhaust gas stream. Calculation of the reducing agent injection rate signal may involve applying a dynamic weighting factor to predetermined minimum and maximum allowable injection rates to obtain a weighted injection rate based upon operating parameters of the exhaust gas stream and/or the AT system.

### INTRODUCTION

Exhaust gases emitted from internal combustion engines typically include a heterogeneous mixture of carbon monoxide (CO), hydrocarbons (HC), and nitrogen oxides (NOₓ), as well as condensed phase materials (liquids and solids) that constitute particulate matter. Exhaust gas aftertreatment systems are oftentimes employed to reduce the levels of CO, HC, NOR, and particulate matter in an exhaust gas stream prior to discharging the exhaust gas into the surrounding environment. Such aftertreatment systems typically include an oxidation catalyst (OC) that oxidizes CO and HC to carbon dioxide (CO₂) and water, a selective catalytic reduction (SCR) device that reduces the NO to nitrogen and water, and a particulate filter (PF) that captures and thereby removes particulate matter from the exhaust gas stream. Particulate filters may need to be regenerated from time to time to remove particulate matter that has built up on the filter during operation of the engine. In some aftertreatment systems, a SCR device may be combined with a particulate filter in an exhaust gas aftertreatment system to form of a selective catalytic reduction filter (SCRF).

SCR devices typically include a substrate or support with a catalyst compound disposed thereon that is formulated to promote the reduction of NO in the exhaust gas to nitrogen and water. In practice, a reducing agent is typically sprayed or injected into the exhaust gas stream upstream of the SCR device and is adsorbed onto the catalyst of the SCR device. When a NOR-containing exhaust gas stream passes through the SCR device, the adsorbed reducing agent reduces the NO to nitrogen and water in the presence of the catalyst. Ammonia (NH₃) is commonly used as a reducing agent in exhaust gas aftertreatment systems and is generally supplied thereto by injecting an aqueous urea solution into the exhaust gas stream, wherein the urea solution rapidly decomposes to NH₃ upon exposure to the hot exhaust gas.

When excess urea is injected into an exhaust gas stream, the excess urea may pass through the SCR device without decomposing into NH₃ and/or without the NH₃ reacting with NO in the exhaust gas stream. In addition, in some instances, when excess urea is injected into the exhaust gas stream, the excess urea may form solid, inactive deposits within the aftertreatment system and within the SCR device, which may reduce the NO conversion efficiency of the SCR device. Therefore, it is desirable to control the amount of urea injected into an exhaust gas stream upstream of an SCR device in an exhaust gas aftertreatment system.

### SUMMARY

In a method for controlling injection of a reducing agent into an exhaust gas stream of an internal combustion engine upstream of a selective catalytic reduction (SCR) device, a minimum allowable injection rate (min INJ rate) and a maximum allowable injection rate (max INJ rate) for injection of a reducing agent into an aftertreatment (AT) system for the exhaust gas stream may be determined. The min INJ rate may be determined based upon operating parameters of the exhaust gas stream and a desired minimum deposition rate (min DEP rate) for deposition of the reducing agent in the AT system. The max INJ rate may be determined based upon operating parameters of the exhaust gas stream and a calculated maximum allowable deposition rate (max DEP rate) for deposition of the reducing agent in the AT system. A dynamic weighting factor for injection of the reducing agent into the AT system may be calculated based upon operating parameters of the AT system. The dynamic weighting factor may be applied to the min INJ rate and the max INJ rate to obtain a weighted injection rate (weighted INJ rate). The weighted INJ rate may be compared to an optimum injection rate (opt INJ rate) for injection of the reducing agent into the AT system to achieve a calculated maximum NOₓ conversion efficiency. The lowest injection rate between the weighted INJ rate and the opt INJ rate may be selected. Injection of the reducing agent into the AT system may be initiated at the selected lowest injection rate.

The dynamic weighting factor may balance the min INJ rate relative to the max INJ rate based upon operating parameters of the AT system.

The AT system may include a selective catalytic reduction (SCR) device having a reducing agent storage concentration. In such case, the max DEP rate may be based upon the reducing agent storage concentration of the SCR device.

The opt INJ rate may be based upon an amount of NOₓ in the exhaust gas stream upstream of the SCR device and the reducing agent storage concentration of the SCR device.

The min INJ rate may be based upon the min DEP rate, a mass flow rate of the exhaust gas stream, a temperature of the exhaust gas stream, and a temperature of the reducing agent injected into the AT system.

The max INJ rate may be based upon the max DEP rate, a mass flow rate of the exhaust gas stream, a temperature of the exhaust gas stream, and a temperature of the reducing agent injected into the AT system.

The dynamic weighting factor may be based upon a calculated actual NOₓ conversion efficiency of a selective catalytic reduction (SCR) device of the AT system, an estimated soot loading of a particulate filter (PF) device of the AT system, and a total amount of accumulated reducing agent deposits in the AT system.

The calculated actual NOₓ conversion efficiency of the SCR device may be based upon a sensed amount of NOₓ in the exhaust gas stream upstream of the SCR device and a sensed amount of NOₓ in the exhaust gas stream downstream of the SCR device.

The estimated soot loading of the PF device may be based upon a measured differential pressure across the PF device, a time since a regeneration event of the PF device, or an amount of fuel burned by the engine since a regeneration event of the PF device.

The total amount of accumulated reducing agent deposits in the AT system may be based upon the selected lowest injection rate at which the reducing agent was injected into the AT system, a time since a regeneration event of the PF device, a mass flow rate of the exhaust gas stream, a temperature of the exhaust gas stream, and a temperature of the reducing agent injected into the AT system.

The dynamic weighting factor may consist of a value in the range of 0 to 1. In such case, the dynamic weighting factor may be respectively applied to the min INJ rate and the max INJ rate to obtain a minimum injection rate component (min INJ rate component) and a maximum injection rate component (max INJ rate component).

The min INJ rate component (INJ_{compA}) and the max INJ rate component (INJ_{compB}) may be obtained by applying the dynamic weighting factor (K_{dwf}) to the min INJ rate (INJₘᵢₙ) and to the max INJ rate (INJₘₐₓ) according to the following equations:

INJ_{compA}=INJₘᵢₙ*(1−K_{dwf})

INJ_{compB}=INJₘₐₓ*K_{dwf}.

The weighted INJ rate may be calculated as the sum of the min INJ rate component and the max INJ rate component.

A regeneration event may be initiated when the estimated soot loading of PF device is greater than or equal to a threshold amount.

An aftertreatment (AT) system for an exhaust gas stream of an internal combustion engine may comprise a selective catalytic reduction (SCR) device, a particulate filter (PF) device, a reducing agent injection system, and a reducing agent injection rate control system embedded in an engine control module comprising a processor coupled to memory. The reducing agent injection system may comprise a reducing agent supply source, a control valve, and an injector configured to inject a reducing agent into an exhaust gas stream at a location upstream of the SCR device. The reducing agent injection rate control system may be configured to determine a minimum allowable injection rate (min INJ rate) and a maximum allowable injection rate (max INJ rate) for injection of the reducing agent into the exhaust gas stream, to calculate a dynamic weighting factor for injection of the reducing agent into the exhaust gas stream, to apply the dynamic weighting factor to the min INJ rate and the max INJ rate to obtain a weighted injection rate (weighted INJ rate), to compare the weighted INJ rate to an optimum injection rate (opt INJ rate) for injection of the reducing agent into the exhaust gas stream to achieve a calculated maximum NOₓ conversion efficiency, to select the lowest injection rate between the weighted INJ rate and the opt INJ rate, and to apply the selected lowest injection rate to the control valve of the reducing agent injection system to control the amount of reducing agent injected by the injector into the exhaust gas stream.

An exhaust gas mass flow rate sensor may be included in the AT system and may be configured to send input signals to the control module that indicate a mass flow rate of the exhaust gas stream.

An exhaust gas temperature sensor may be included in the AT system upstream of the SCR device and may be configured to send input signals to the control module that indicate a temperature of the exhaust gas stream at a location upstream of the SCR device.

A first NOₓ/NH₃ sensor may be included in the AT system upstream of the SCR device and a second NOₓ/NH₃ sensor may be included in the AT system downstream of the SCR device. The first and second NOₓ/NH₃ sensors each may be configured to send input signals to the control module that indicate an amount of NOₓ and NH₃ in the exhaust gas stream, with the first NOₓ/NH₃ sensor indicating the amount of NOₓ and NH₃ in the exhaust gas stream entering the SCR device and the second NOₓ/NH₃ sensor indicating the amount of NOₓ and NH₃ in the exhaust gas stream exiting the SCR device.

An SCR substrate temperature sensor may be included in the AT system and configured to send input signals to the control module that indicate a temperature of a catalyst substrate of the SCR device.

A reducing agent temperature sensor may be included in the AT system and configured to send input signals to the control module that indicate a temperature of a reducing agent supply source.

### BRIEF DESCRIPTION OF THE DRAWINGS

FIG. 1 is a functional block diagram of an exhaust gas aftertreatment system for an internal combustion engine, including an oxidation catalyst device, a selective catalytic reduction device, a particulate filter device, a reducing agent injection system, and an engine control module; and

FIG. 2 is a dataflow diagram illustrating an injection rate control system for determining a reducing agent injection rate signal to be applied to the reducing agent injection system of FIG. 1.

### DETAILED DESCRIPTION

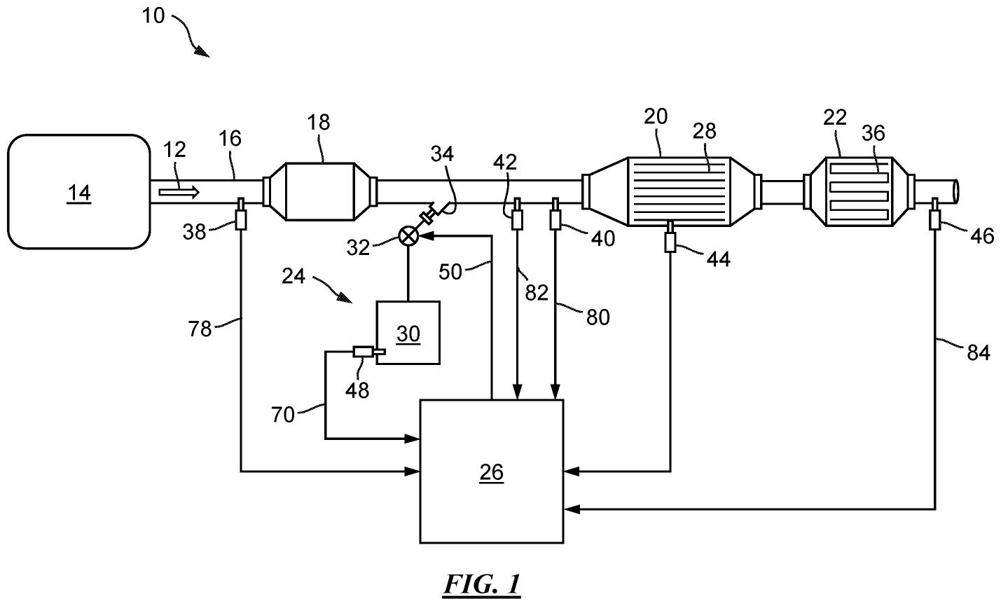

FIG. 1 illustrates in idealized fashion an exhaust gas aftertreatment (AT) system 10 for the reduction and/or removal of certain exhaust gas constituents present in an exhaust gas stream 12 produced by an internal combustion engine 14, e.g., of an automotive vehicle (not shown). The AT system 10 described herein can be used in combination with various internal combustion engine systems including, but are not limited to, diesel engine systems, gasoline direct injection systems, and homogeneous charge compression ignition engine systems.

The AT system 10 is in fluid communication with the internal combustion engine 14 and includes an exhaust gas conduit 16 and multiple serially-arranged exhaust gas treatment devices, including an oxidation catalyst (OC) device 18, a selective catalytic reduction (SCR) device 20 downstream of the OC device 18, and a particulate filter (PF) device 22 downstream of the SCR device 20, although other arrangements are certainly possible. For example, in other embodiments, the SCR device 20 may be combined with the PF device 22 to form a selective catalytic reduction filter (not shown). Additionally or alternatively, other exhaust gas treatment devices (not shown) may be included in the AT system 10. The AT system 10 described herein is not limited to the arrangement depicted in FIG. 1. The exhaust gas conduit 16 transports the exhaust gas stream 12 from the engine 14 to the various exhaust treatment devices of the AT system 10. The AT system 10 also includes a reducing agent injection system 24 configured to inject a reducing agent into the exhaust gas stream 12 upstream of the SCR device 20. An engine control module 26 is associated with the vehicle and is configured (e.g., programmed and equipped with hardware) to monitor and control the engine 14, the various components of the AT system 10, and the exhaust gas stream 12 passing therethrough.

The OC device 18 may be configured to remove unburned gaseous and non-volatile hydrocarbons (HC) and carbon monoxide (CO) from the exhaust gas stream 12 through oxidation and may include a flow-through metal or ceramic monolith substrate (not shown) packaged in a shell or canister having an inlet and an outlet in fluid communication with the exhaust gas conduit 16.

The SCR device 20 is configured to remove nitrogen oxides (NOₓ) from the exhaust gas stream 12 via reduction of NOₓ (e.g., NO, NO₂, N₂O, etc.) to nitrogen and water. Like the OC device 18, the SCR device 20 also may include a flow-through ceramic or metal monolith substrate 28 packaged in a shell or canister having an inlet and an outlet in fluid communication with exhaust gas conduit 16. The monolith substrate 28 of the SCR device 20 may be coated with a catalyst composition that is formulated to promote the reduction and removal of NOₓ from the exhaust gas stream 12 in the presence a reducing agent, for example, in the presence of ammonia (NH₃).

The reducing agent injection system 24 includes a reducing agent supply source 30, a control valve 32, and an injector 34, and is configured to periodically or continuously supply the SCR device 20 with a metered amount of a reducing agent, for example, by injecting the reducing agent (or a precursor thereof) into the exhaust gas stream 12 via the injector 34 at a location upstream of the SCR device 20. The reducing agent is stored within the supply source 30 and may be in the form of a gas or a liquid. In one form, the reducing agent may comprise an aqueous urea (CO(NH₂)₂) solution that is formulated to decompose to NH₃ upon exposure to the hot exhaust gas stream 12, for example, at temperatures greater than about 250° C. After the reducing agent is injected into the exhaust gas stream 12, the reducing agent enters the SCR device 20 along with the exhaust gas stream 12 and is adsorbed onto the monolith substrate 28 of the SCR device 20. When the exhaust gas stream 12 passes through the SCR device 20, the reducing agent desorbs from the substrate 28 and reacts with NOₓ in the exhaust gas stream 12 by reducing the NOₓ to nitrogen and water in the presence of the catalyst coated on the substrate 28.

To effectively remove NOₓ from the exhaust gas stream 12, without using an excess amount of the reducing agent, it is generally desirable to control the amount of the reducing agent injected into the exhaust gas stream 12 so that the concentration of the reducing agent and the concentration of NOₓ in the exhaust gas stream 12 are stoichiometric. If the reducing agent (e.g., NH₃) storage concentration of the substrate 28 (e.g., the amount of NH₃ stored on the substrate 28 expressed as a percentage of the overall NH₃ storage capacity of the substrate 28) is less 100%, excess reducing agent injected into the exhaust gas stream 12 may be stored on the substrate 28 until the NH₃ storage capacity of the substrate 28 is reached. When the NH₃ storage capacity of the substrate 28 is reached, any excess reducing agent injected into the exhaust gas stream 12 may be released from the AT system 10 in a phenomenon commonly referred to as “NH₃ slip.” In some situations, when the reducing agent is injected into the exhaust gas stream 12 at relatively low temperatures (e.g., less than 250° C.) or in excess amounts, solid urea deposits may form and accumulate in the AT system 10, for example, on an interior surface of the conduit 16 and within the SCR device 20, which may reduce the long-term catalytic performance (and thus the NOₓ conversion efficiency) of the SCR device 20.

The PF device 22 is configured to remove particulate matter, e.g., soot, from the exhaust gas stream 12 and may include a ceramic monolith substrate 36 with porous walls that define a plurality of plugged channels. The plugged channels force the exhaust gas stream 12 to flow through the porous walls of the substrate 36 such that the particulate matter in the exhaust gas stream 12 is trapped in the PF device 22 and collects on the walls of the substrate 36 in a process commonly referred to as “soot loading.” Once the amount of particulate matter collected on the substrate 36 of the PF device 22 reaches a threshold amount, the PF device 22 is regenerated, typically by heating the PF device 22 to a temperature sufficient to burn the collected particulate matter, thereby converting the particulate matter to carbon dioxide. It has been found that, when the PF device 22 is regenerated by directing a high temperature exhaust gas stream 12 (e.g., at temperatures greater than 450° C.) through the AT system 10, the high temperature exhaust gas stream 12 not only burns off the particulate matter collected within the PF device 22 but also has the benefit of evaporating and/or burning off any accumulated reducing agent deposits within the AT system 10.

The engine control module 26 is operably connected to a plurality of sensors and to a plurality of actuators associated with the engine 14 and the AT system 10. The sensors provide the control module 26 with input signals related to various operating parameters of the engine 14, the exhaust gas stream 12, and the AT system 10. The control module 26 is operable to monitor and interpret the input signals received from the sensors, to synthesize and/or compute pertinent information (e.g., using calibration lookup tables), and to execute algorithms to control the actuators to achieve certain control targets, such as vehicle performance, fuel economy, emissions reduction, and protection of hardware components, such as the hardware components of the AT system 10.

As shown in FIG. 1, the control module 26 may be operably coupled to and receive input signals from an exhaust gas mass flow rate sensor 38, an exhaust gas temperature sensor 40 upstream of the SCR device 20, a first NOₓ/NH₃ sensor 42 upstream of the SCR device 20, an SCR substrate temperature sensor 44, a second NOₓ/NH₃ sensor 46 downstream of the SCR device 20, and a reducing agent temperature sensor 48. The first and second NOₓ/NH₃ sensors 42, 46 are respectively located upstream and downstream of the SCR device 20 and are each configured to send input signals to the control module 26 that indicate the amount of NOₓ and NH₃ in the exhaust gas stream 12, with the first NOₓ/NH₃ sensor 42 indicating the amount of NOₓ and NH₃ in the exhaust gas stream 12 entering the SCR device 20 and the second NOₓ/NH₃ sensor 46 indicating the amount of NOₓ and NH₃ in the exhaust gas stream 12 exiting the SCR device 20. In practice, the control module 26 may be operably coupled to one of more additional sensors not shown in FIG. 1, for example, such as a pair of first and second pressure sensors respectively located upstream and downstream of the PF device 22. Based upon input signals received from the sensors 38, 40, 42, 44, 46, and/or 48, as well as other input signals, the control module 26 outputs a reducing agent injection rate signal 50, which is applied to the valve 32 to control the amount of reducing agent injected by the injector 34 into the exhaust gas stream 12 flowing through the conduit 16. The reducing agent injection rate signal 50 also acts as a feedback input signal to the control module 26.

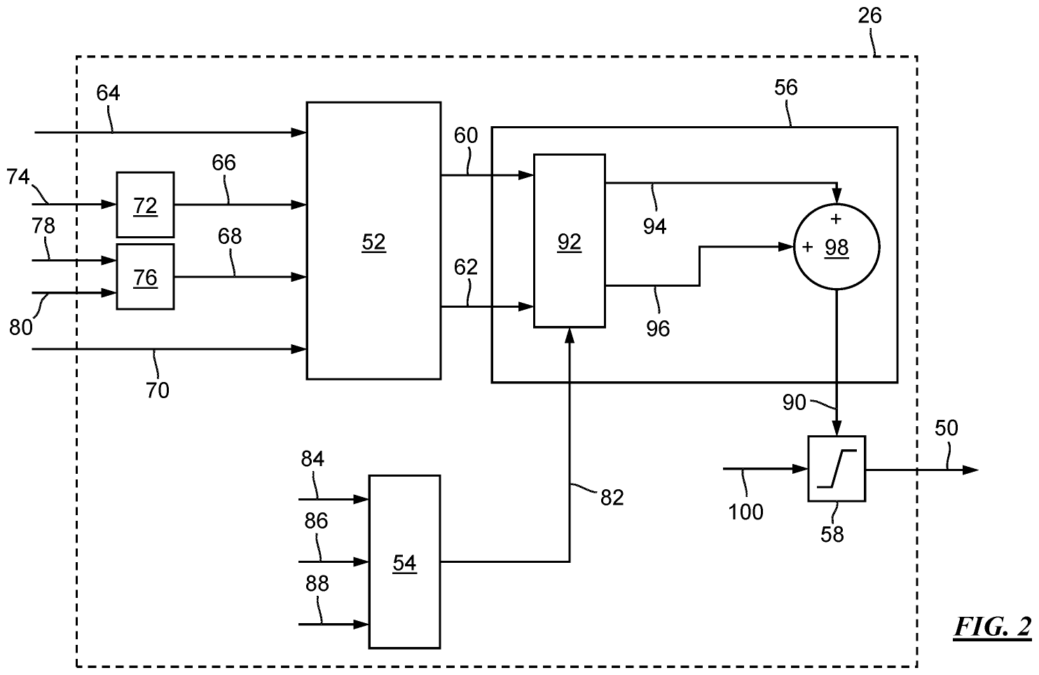

FIG. 2 illustrates a dataflow diagram of a reducing agent injection rate control system which may be embedded in the engine control module 26 and used to determine the reducing agent injection rate signal 50 to be applied to the valve 32. The injection rate control system may include any number of sub-modules embedded within the control module 26. In addition to the input signals received from the sensors 38, 40, 42, 44, 46, and/or 48, input signals received by the injection rate control system may be received from other sensors, other control modules (not shown), and/or other sub-modules (not shown) within the control module 26. For example, the injection rate control system may receive input signals from a PF regeneration module and/or a vehicle operation module, which may indicate the amount of soot accumulated on the substrate 36 of the PF device 22, the time since the last regeneration event of the PF device 22, the distance traveled by the vehicle since the last regeneration event of the PF device 22, and/or the amount of fuel burned by the engine 14 since the last regeneration event of the PF device 22.

The injection rate control system embedded in the control module 26 is configured to output a reducing agent (e.g., urea) injection rate signal 50 that strikes a balance between achieving maximum NOₓ conversion efficiency within the SCR device 20, while also limiting the amount of accumulated reducing agent deposits within the AT system 10 so as to avoid long-term negative impacts on the NOₓ conversion efficiency of the SCR device 20. The injection rate control system disclosed herein does not require the initiation of additional regeneration events to control the amount of accumulated reducing agent deposits within the AT system 10. That is, the injection rate control system disclosed herein does not increase the number of regeneration events of the PF device 22 beyond that which would normally occur during operation of the engine 14 due to the normal accumulation of soot on the substrate 36 of the PF device 22, wherein regeneration of the PF device 22 is only initiated when the amount of particulate matter collected on the substrate 36 of the PF device 22 reaches a threshold amount.

To accomplish the above goals, the injection rate control system generally allows for the continued formation and buildup of urea deposits within the AT system 10 when (i) the NH₃ storage concentration of the substrate 28 of the SCR device 20 is low, (ii) the NOₓ conversion efficiency of the SCR device 20 remains high, (iii) the total estimated amount of urea deposits within the AT system 10 is low, and/or (iv) the soot loading on the substrate 36 of the PF device 22 is approaching 100%, meaning that a regeneration event of the PF device 22 will occur soon and will have the effect of eliminating any accumulated urea deposits within the AT system 10. At the same time, the injection rate control system generally inhibits or prevents the continued formation and buildup of urea deposits within the AT system 10 when (i) the NH₃ storage concentration of the substrate 28 of the SCR device 20 is high, (ii) the total estimated amount of urea deposits within the AT system 10 is high, (iii) the NOₓ conversion efficiency of the SCR device 20 is reduced, and/or (iv) the soot loading on the substrate 36 of the PF device 22 is low, meaning that a regeneration event of the PF device 22 is not anticipated in the near future. Based upon the above parameters, immediately after an active regeneration event of the PF device 22, the injection rate signal 50 output by the control module 26 may be relatively high and may allow for a relatively high urea injection rate to achieve maximum NOₓ conversion efficiency within the SCR device 20, without resulting in NH₃ slip. As the amount of urea deposits build up in the AT system 10, the injection rate signal 50 output by the control module 26 will gradually decrease until another active regeneration event of the PF device 22 occurs, or until the estimated amount of urea deposits in the AT system 10 is reduced as a result of passive conditions within the AT system 10 (e.g., increased exhaust gas temperatures).

As shown in FIG. 2, the injection rate control system embedded in the control module 26 may include an initial minimum/maximum injection rate module (min/max INJ rate module) 52, a dynamic weighting factor module 54, an adjustment module 56, and a limit module 58.

The min/max INJ rate module 52 determines via a calibration lookup table a minimum allowable injection rate (min INJ rate) 60 and a maximum allowable injection rate (max INJ rate) 62 (e.g., in units of milligrams per second, mg/s) for injection of a reducing agent (e.g., urea) into the exhaust gas stream 12 based upon input signals 64, 66, and 68, and optionally 70. The min INJ rate 60 and the max INJ rate 62 represent initial minimum and maximum injection rates, whose values will be assigned different weights based upon the operating conditions of the AT system 10 and subsequently used in determining the final injection rate signal 50 output by the control module 26.

Input signals 64 and 66 respectively represent a desired minimum deposition rate (min DEP rate) and a maximum allowable deposition (max DEP rate) (e.g., in units of mg/s) for deposition of the reducing agent on the interior surface of the conduit 16 and/or the substrate 28 of the SCR device 20. The min DEP rate 64 may be a preset value and may be selected based upon the physical parameters and/or operating parameters of engine 14 and/or the AT system 10. The max DEP rate 66 may be calculated by a max DEP rate module 72 embedded in the control module 26 and may be based upon a NH₃ storage concentration 74 of the substrate 28 of the SCR device 20. The NH₃ storage concentration 74 may be calculated (e.g., as a percentage) based upon input signals 82, 84 respectively received from the first and second NOₓ/NH₃ sensors 42, 46, the exhaust gas mass flow rate sensor 38, the exhaust gas temperature sensor 40, and/or the SCR substrate temperature sensor 44. Input signal 68 represents the energy (e.g., in Joules per second, J/s) of the exhaust gas stream 12 and may be calculated by an exhaust gas energy module 76 embedded in the control module 26 and may be based upon the exhaust gas mass flow rate signal 78 (received from sensor 38) and the exhaust gas temperature signal 80 (received from sensor 40). Optional input signal 70 represents the temperature of the reducing agent supply source 30 received from the reducing agent temperature sensor 48.

The dynamic weighting factor module 54 calculates a unitless dynamic weighting factor 82 having a value in the range of 0 to 1 and based upon input signals 84, 86, and 88. Input signal 84 represents a calculated actual NOₓ conversion efficiency of the SCR device 20 that may be calculated as a percentage based upon input signals 82, 84 respectively received from the first and second NOₓ/NH₃ sensors 42, 46. Input signal 86 represents an estimated soot loading on the substrate 36 of the PF device 22, as compared to a threshold amount of soot loading that would trigger a regeneration event, and may be calculated as a percentage based upon input signals received from a PF regeneration module and/or a vehicle operation module, which may indicate a measured differential pressure across the substrate 36 of the PF device 22, the time since the last regeneration event of the PF device 22, the distance traveled by the vehicle since the last regeneration event of the PF device 22, and/or the amount of fuel burned by the engine 14 since the last regeneration event of the PF device 22. Input signal 88 represents a total amount of accumulated reducing agent deposits in the AT system 10 (e.g., in units of grams, g) and may be calculated based upon the exhaust gas mass flow rate signal 78 (received from sensor 38), the exhaust gas temperature signal 80 (received from sensor 40), the actual reducing agent injection rate signal 50, and/or the reducing agent temperature signal 70 (received from the reducing agent temperature sensor 48).

The adjustment module 56 calculates a weighted injection rate (weighted INJ rate) 90 (e.g., in units of mg/s) for injection of the reducing agent into the exhaust gas stream 12 based upon the min INJ rate 60 and the max INJ rate 62 received from the min/max INJ rate module 52 and the unitless dynamic weighting factor 82 received from the dynamic weighting factor module 54.

The dynamic weighting factor 82 represents the relative importance of the min INJ rate 60 and the max INJ rate 62 under the current operating conditions of the AT system 10 based upon the input signals 84, 86, and 88. The dynamic weighting factor 82 is applied to the min INJ rate 60 and separately to the max INJ rate 62 in a sub-module 92 of the adjustment module 56 to respectively obtain a minimum injection rate component (min INJ rate component) 94 and a maximum injection rate component (max INJ rate component) 96. The dynamic weighting factor 82 may be respectively applied to the min INJ rate 60 and the max INJ rate 62 according to the following equations:

INJ_{compA}=INJₘᵢₙ*(1−K_{dwf}) (1)

INJ_{compB}=INJₘₐₓ*K_{dwf} (2)

where INJ_{compA} is the min INJ rate component 94, INJ_{compB} is the max INJ rate component 96, K_{dwf} is the dynamic weighting factor 82, INJₘᵢₙ is the min INJ rate 60, and INJₘₐₓ is the max INJ rate 62. The min INJ rate component 94 and the max INJ rate component 96 are added together at a summing junction 98 of the adjustment module 56 to obtain the weighted INJ rate 90.

The limit module 58 determines the reducing agent injection rate signal 50 to be applied to the injector 32 by comparing the weighted INJ rate 90 received from the adjustment module 56 to an optimum injection rate (opt INJ rate) 100, and then selecting the lowest injection rate between the rate 90 and the rate 100 as the reducing agent injection rate signal 50. The opt INJ rate 100 indicates an optimum amount of reducing agent for injecting into the exhaust gas stream 12 to achieve maximum NOₓ conversion efficiency over the substrate 28 of the SCR device 20, without resulting in NH₃ slip (or without resulting in an amount of NH₃ slip greater than a threshold amount). The opt INJ rate 100 may be calculated based upon the amount of NOₓ in the exhaust gas stream 12 entering the SCR device 20 (i.e., input signal 82 received from the first NOₓ/NH₃ sensor 42) and the NH₃ storage concentration 74 of the substrate 28 of the SCR device 20.

The above description of preferred exemplary embodiments, aspects, and specific examples are merely descriptive in nature; they are not intended to limit the scope of the claims that follow. Each of the terms used in the appended claims should be given its ordinary and customary meaning unless specifically and unambiguously stated otherwise in the specification.

What is claimed is:

1. A method for controlling injection of a reducing agent into an exhaust gas stream of an internal combustion engine upstream of a selective catalytic reduction (SCR) device, the method comprising:
determining a minimum allowable injection rate (min INJ rate) for injection of a reducing agent into an aftertreatment (AT) system for an exhaust gas stream of an internal combustion engine based upon operating parameters of the exhaust gas stream and a desired minimum deposition rate (min DEP rate) for deposition of the reducing agent in the AT system;
determining a maximum allowable injection rate (max INJ rate) for injection of the reducing agent into the AT system based upon operating parameters of the exhaust gas stream and a calculated maximum allowable deposition rate (max DEP rate) for deposition of the reducing agent in the AT system;
calculating a dynamic weighting factor for injection of the reducing agent into the AT system based upon operating parameters of the AT system;
applying the dynamic weighting factor to the min INJ rate and the max INJ rate to obtain a weighted injection rate (weighted INJ rate);
comparing the weighted INJ rate to an optimum injection rate (opt INJ rate) for injection of the reducing agent into the AT system to achieve a calculated maximum NOₓ conversion efficiency;
selecting the lowest injection rate between the weighted INJ rate and the opt INJ rate; and
initiating injection of the reducing agent into the AT system at the selected lowest injection rate.

2. The method of claim 1 wherein the dynamic weighting factor balances the min INJ rate relative to the max INJ rate based upon operating parameters of the AT system.

3. The method of claim 1 wherein the AT system includes a selective catalytic reduction (SCR) device having a reducing agent storage concentration, and wherein the max DEP rate is based upon the reducing agent storage concentration of the SCR device.

4. The method of claim 3 wherein the opt INJ rate is based upon an amount of NOₓ in the exhaust gas stream upstream of the SCR device and the reducing agent storage concentration of the SCR device.

5. The method of claim 1 wherein the min INJ rate is based upon the min DEP rate, a mass flow rate of the exhaust gas stream, a temperature of the exhaust gas stream, and a temperature of the reducing agent injected into the AT system.

6. The method of claim 1 wherein the max INJ rate is based upon the max DEP rate, a mass flow rate of the exhaust gas stream, a temperature of the exhaust gas stream, and a temperature of the reducing agent injected into the AT system.

7. The method of claim 1 wherein the dynamic weighting factor is based upon a calculated actual NOₓ conversion efficiency of a selective catalytic reduction (SCR) device of the AT system, an estimated soot loading of a particulate filter (PF) device of the AT system, and a total amount of accumulated reducing agent deposits in the AT system.

8. The method of claim 7 wherein the calculated actual NOₓ conversion efficiency of the SCR device is based upon a sensed amount of NOₓ in the exhaust gas stream upstream of the SCR device and a sensed amount of NOₓ in the exhaust gas stream downstream of the SCR device.

9. The method of claim 7 wherein the estimated soot loading of the PF device is based upon a measured differential pressure across the PF device, a time since a regeneration event of the PF device, or an amount of fuel burned by the engine since a regeneration event of the PF device.

10. The method of claim 7 wherein the total amount of accumulated reducing agent deposits in the AT system is based upon the selected lowest injection rate at which the reducing agent was injected into the AT system, a time since a regeneration event of the PF device, a mass flow rate of the exhaust gas stream, a temperature of the exhaust gas stream, and a temperature of the reducing agent injected into the AT system.

11. The method of claim 7 comprising:
initiating a regeneration event when the estimated soot loading of the PF device is greater than or equal to a threshold amount.

12. The method of claim 1 wherein the dynamic weighting factor consists of a value in the range of 0 to 1, and wherein the dynamic weighting factor is respectively applied to the min INJ rate and the max INJ rate to obtain a minimum injection rate component (min INJ rate component) and a maximum injection rate component (max INJ rate component).

13. The method of claim 12 wherein the min INJ rate component (INJ_{compA}) and the max INJ rate component (INJ_{compB}) are obtained by applying the dynamic weighting factor (K_{dwf}) to the min INJ rate (INJₘᵢₙ) and to the max INJ rate (INJₘₐₓ) according to the following equations:
INJ_{compA}=INJₘᵢₙ*(1−K_{dwf})
INJ_{compB}=INJₘₐₓ*K_{dwf}.

14. The method of claim 13 wherein the weighted INJ rate is calculated as the sum of the min INJ rate component and the max INJ rate component.

15. An aftertreatment (AT) system for an exhaust gas stream of an internal combustion engine, the AT system comprising:
a selective catalytic reduction (SCR) device,
a particulate filter (PF) device;
a reducing agent injection system including a reducing agent supply source, a control valve, and an injector configured to inject a reducing agent into an exhaust gas stream at a location upstream of the SCR device;
a reducing agent injection rate control system embedded in an engine control module comprising a processor coupled to memory, the injection rate control system configured to:
determine a minimum allowable injection rate (min INJ rate) for injection of the reducing agent into the exhaust gas stream;
determine a maximum allowable injection rate (max INJ rate) for injection of the reducing agent into the exhaust gas stream;
calculate a dynamic weighting factor for injection of the reducing agent into the exhaust gas stream;
apply the dynamic weighting factor to the min INJ rate and the max INJ rate to obtain a weighted injection rate (weighted INJ rate);
compare the weighted INJ rate to an optimum injection rate (opt INJ rate) for injection of the reducing agent into the exhaust gas stream to achieve a calculated maximum NOₓ conversion efficiency;
select the lowest injection rate between the weighted INJ rate and the opt INJ rate; and
apply the selected lowest injection rate to the control valve of the reducing agent injection system to control the amount of reducing agent injected by the injector into the exhaust gas stream.

16. The system of claim 15 comprising an exhaust gas mass flow rate sensor configured to send input signals to the control module that indicate a mass flow rate of the exhaust gas stream.

17. The system of claim 15 comprising an exhaust gas temperature sensor upstream of the SCR device, the exhaust gas temperature sensor configured to send input signals to the control module that indicate a temperature of the exhaust gas stream at a location upstream of the SCR device.

18. The system of claim 15 comprising a first NOₓ/NH₃ sensor upstream of the SCR device and a second NOₓ/NH₃ sensor downstream of the SCR device, and wherein the first and second NOₓ/NH₃ sensors are each configured to send input signals to the control module that indicate an amount of NOₓ and NH₃ in the exhaust gas stream, with the first NOₓ/NH₃ sensor indicating the amount of NOₓ and NH₃ in the exhaust gas stream entering the SCR device and the second NOₓ/NH₃ sensor indicating the amount of NOₓ and NH₃ in the exhaust gas stream exiting the SCR device.

19. The system of claim 15 comprising an SCR substrate temperature sensor configured to send input signals to the control module that indicate a temperature of a catalyst substrate of the SCR device.

20. The system of claim 15 comprising a reducing agent temperature sensor configured to send input signals to the control module that indicate a temperature of a reducing agent supply source.
